(19) United States
(12) Patent Application Publication
(10) Pub. No.: US 2024/0388077 A1
(43) Pub. Date: Nov. 21, 2024

(54) Retractable Cord

(71) Applicant: PJ Antonik, Hingham, MA (US)

(72) Inventor: PJ Antonik, Hingham, MA (US)

(21) Appl. No.: 18/668,315

(22) Filed: May 20, 2024

Related U.S. Application Data
(60) Provisional application No. 63/467,930, filed on May 20, 2023.

(51) Int. Cl. H02G 11/02; H01R 13/72; H01R 13/74; H01R 25/00; H02G 3/08

(52) U.S. Cl. CPC H02G 11/02; H01R 13/72; H01R 13/74; H01R 25/006; H02G 3/081

(57) ABSTRACT

Systems and devices for providing electrical power are provided with a mounting section configured to connect to external electrical power and convey electrical power to a removable core. The removable core is configured to be inserted into and removed from the mounting section. The removable core consists of a power connection configured to receive the electrical power from the mounting section and convey the electrical power through a retractable cord. The removable core further consists of a reel configured to dispense and retract the retractable cord.

### RELATED APPLICATIONS

The present application claims priority to U.S. provisional patent application No. 63/467,930.

### TECHNICAL FIELD

The present invention relates generally to systems, devices, and methods for electrical cord management.

### SUMMARY OF THE INVENTION

In a first aspect, the disclosure provides a device for providing electrical power. A mounting section is configured to connect to external electrical power and convey electrical power to a removable core. The removable core is configured to be inserted into and removed from the mounting section. The removable core consists of a power connection configured to receive the electrical power from the mounting section and convey the electrical power through a retractable cord. The removable core further consists of a reel configured to dispense and retract the retractable cord.

In a second aspect, the disclosure provides a device for providing electrical power. A mounting section has first electrical connections to external electrical power and second electrical connections to a removable core. The removable core is shaped to be inserted into and removed from the mounting section. The removable core consists of a third electrical connection shaped to connect to the second electrical connections and connected to a retractable cord. The removable core further consists of a reel whereon the retractable cord mounts, the reel dispensing and retracting the retractable cord.

Further aspects and embodiments are provided in the foregoing drawings, detailed description and claims.

### BRIEF DESCRIPTION OF DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is an isometric exploded view of a main housing and power board.

FIG. 2 is a side view of the main housing and power board of FIG. 1.

FIG. 3 is a side view of the main housing, not exploded, of FIG. 1.

FIG. 4 is a front view of the main housing of FIG. 3.

FIG. 5 is a cross-sectional view through FIG. 4.

FIG. 6 is a cross-sectional view through FIG. 5.

FIG. 7 is a side view of the main housing of FIG. 3 with an inserted core.

FIG. 8 is a front view of the main housing of FIG. 7.

FIG. 9 is a cross-sectional view through FIG. 8.

FIG. 10 is a cross-sectional view through FIG. 8.

FIG. 11 is a cross-sectional view through FIG. 9 of only the inserted core of FIG. 7.

FIG. 12 is a side view of the core of FIG. 11.

FIG. 13 is an isometric view of the combined main housing, power board, and inserted core of FIGS. 1-12.

FIG. 14 is a side view of the reel inside the inserted core of FIG. 11.

FIG. 15 is a front view of the inserted core of FIG. 14.

FIG. 16 is a cross-section view through FIG. 15.

FIG. 17 is an isometric view of the inserted core of FIG. 14.

FIG. 18 is an exploded view of the reel of FIGS. 14-17.

FIG. 19 is a side view of the left panel of the inserted core of FIG. 11.

FIG. 20 is a top view of the left panel of FIG. 19.

FIG. 21 is a cross-sectional view through the left panel of FIG. 19.

FIG. 22 is an end view of the left panel of FIG. 19.

FIG. 23 is a front isometric view of the left panel of FIG. 19.

FIG. 24 is a back isometric view of the left panel of FIG. 19.

FIG. 25 is a back isometric view of the right panel of the inserted core of FIG. 11.

FIG. 26 is an isometric view of the release button frame for the inserted core of FIGS. 7-10.

FIG. 27 is a front view of the release button frame of FIG. 26.

FIG. 28 is a cross-sectional view through the release button frame of FIG. 27.

FIG. 29 is a back view of the release button frame of FIG. 26.

FIG. 30 is a front view of the release button for the inserted core of FIGS. 7-10.

FIG. 31 is a side view of the release button of FIG. 30.

FIG. 32 is a back view of the release button of FIG. 30.

FIG. 33 is an isometric view of the release button of FIG. 30.

FIG. 34 is a cross-sectional view through the release button of FIG. 30.

FIG. 35 is an isometric view of a secure block for the release button assembly of FIGS. 26 through 34.

FIG. 36 is a cross-sectional cutaway view of a mounted cord dispenser.

### DETAILED DESCRIPTION

At The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The retractable cord device and system, known as the ReelCord herein, is a wall outlet designed to fit in a standard size recessed electrical gang box. The outlet is designed to have a recoilable cable for charging electronic devices. The internal reel is spring loaded, intended to be both manually stopped with a button or automatically stopped with an internal mechanism when it is pulled out to the desired length. The length of the cord is intended to extend as long as desired by the consumer, within limits of the size of the gang box. The reel that the cord coils into is designed to be a removable item powered by electrical contacts on the sides of the center of the reel. The coil is designed to be easily removed by an average person with no electrical experience in order to replace it with a new cord due to wear and tear or an update in technology.

The ReelCord is unlike any other USB or electronic charging outlet build into a wall as it comes with a cord, the cord recoils back into the unit, and the cord is replaceable with a proprietary replacement cord built by ReelCord. The plug on the end is not intended to be a specific type of plug but rather will update and change with the marketplace.

In some embodiments, the invention has standard receptacles such as USB, USB-C, AC, or any other type of receptacle to plug in an electrical piece of equipment. In some embodiments, ReelCords will fit in multiple size gang boxes such as double, triple, or quadruple gang boxes.

Accessories for wireless charging will be built to adapt to the device and plug in to give an additional option of charging wireless devices. The ReelCord will be available in a hard-wired version directly installed into the wall but also a free standing unit that plugs into a standard outlet. This unit will offer multiple cords as well as receptacles for other charging options.

This product solves this with a retractable cord that is inside a wall plug and contains a spring-loaded reel which allows the cord to be retracted from the wall when in use. To stow away, the consumer pulls the cord to retract into wall.

In one embodiment, a device for charging electronic devices is disclosed and consists of a retractable cord contained within a wall plug and a spring-loaded reel to retract the cord when not in use. The invention provides a solution to the cumbersome and cluttered nature of charging electronic devices by allowing the user to retract the cord into the wall plug when not in use. The invention also features a removable core that enables the user to make repairs and upgrades when new or alternative chargers become available.

The present invention relates to a charging cord system for multiple devices, designed to reduce the clutter and inconvenience associated with multiple charging bricks and cords. The system consists of a wall plug with a retractable cord, which is housed in a spring-loaded reel. The cord can be extended from the wall plug for use and retracted when not in use. The core of the system is removable, allowing for easy repairs and upgrades when new or other chargers become available.

In one embodiment, the cord is made of a durable material capable of repeated bending, torsion, twisting, and other typical use issues.

In one embodiment, the removable core is held in place by a locking mechanism.

In one embodiment, the spring-loaded reel is designed to prevent the cord from tangling or becoming kinked.

The length of the cord is only limited by the volume of the space inside the electrical gang box and the distance the power can be transmitted effectively.

In some embodiments, the cord can support multiple devices at once. In some embodiments, the reel carries more than one cord or multiple reels are contained inside one module.

In some embodiments, the cord can be locked in place at various lengths to accommodate different charging needs.

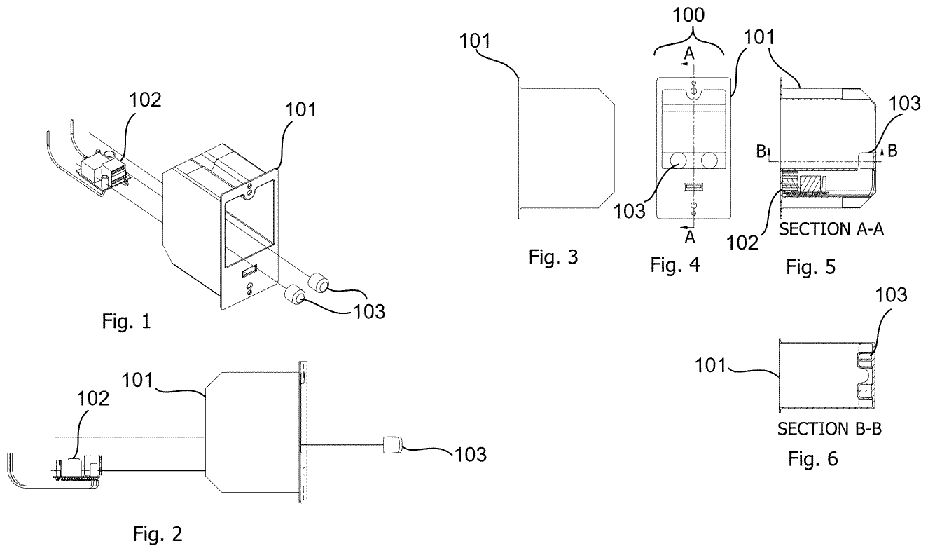

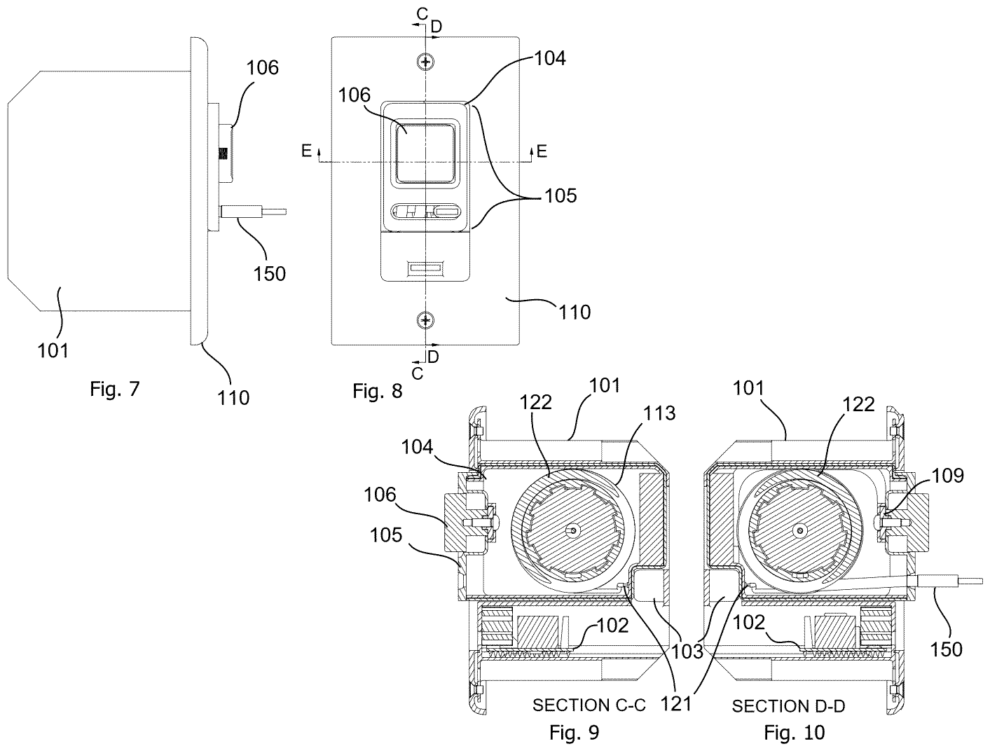

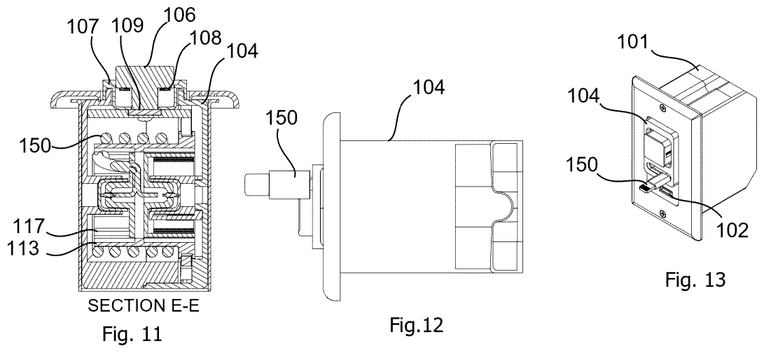

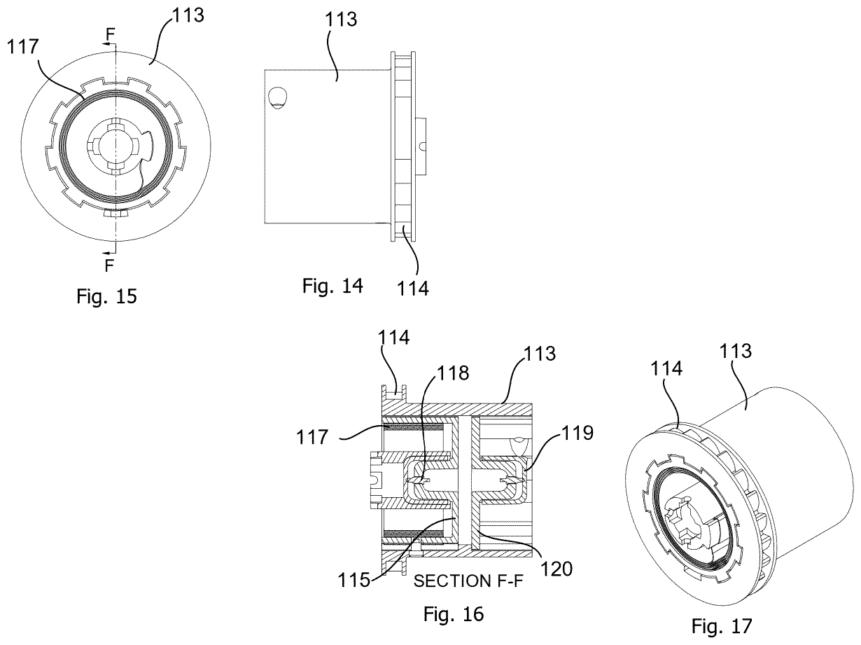

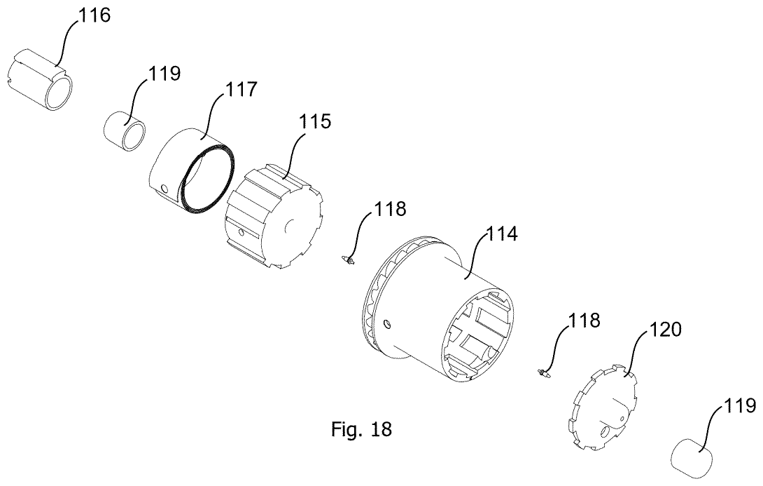

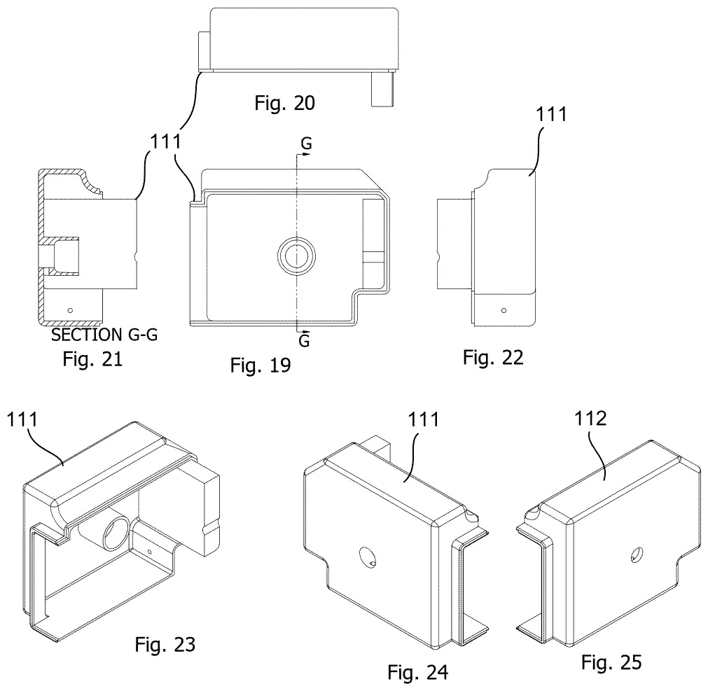

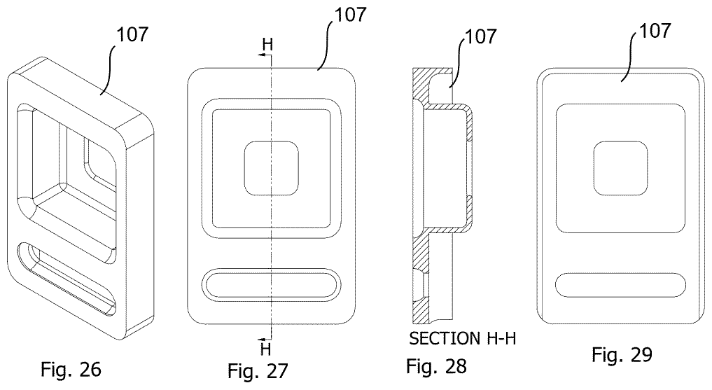

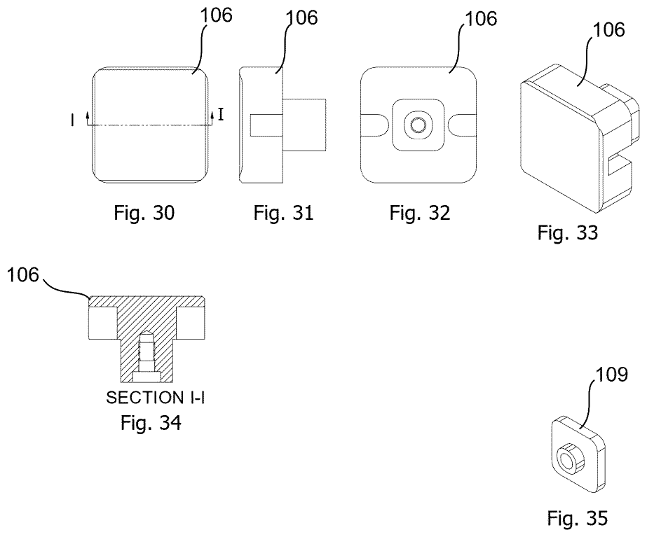

Now referring to the Figures, FIG. 1 is an isometric exploded view of a main housing and power board that may be used in one embodiment of the present invention. FIG. 2 is a side view of the main housing and power board of FIG. 1. FIG. 3 is a side view of the main housing, not exploded, of FIG. 1. FIG. 4 is a front view of the main housing of FIG. 3. FIG. 5 is a cross-sectional view through Section A-A of FIG. 4. FIG. 6 is a cross-sectional view through Section B-B of FIG. 5. FIG. 7 is a side view of the main housing of FIG. 3 with an inserted core. FIG. 8 is a front view of the main housing of FIG. 7. FIG. 9 is a cross-sectional view through Section C-C of FIG. 8. FIG. 10 is a cross-sectional view through Section D-D of FIG. 8. FIG. 11 is a cross-sectional view through Section E-E of FIG. 9 of only the inserted core of FIG. 7. FIG. 12 is a side view of the core of FIG. 11. FIG. 13 is an isometric view of the combined main housing, power board, and inserted core of FIGS. 1-12. FIG. 14 is a side view of the reel inside the inserted core of FIG. 11. FIG. 15 is a front view of the inserted core of FIG. 14. FIG. 16 is a cross-section view through Section F-F of FIG. 15. FIG. 17 is an isometric view of the inserted core of FIG. 14. FIG. 18 is an exploded view of the reel of FIGS. 14-17. FIG. 19 is a side view of the left panel of the inserted core of FIG. 11. FIG. 20 is a top view of the left panel of FIG. 19. FIG. 21 is a cross-sectional view through Section G-G of the left panel of FIG. 19. FIG. 22 is an end view of the left panel of FIG. 19. FIG. 23 is a front isometric view of the left panel of FIG. 19. FIG. 24 is a back isometric view of the left panel of FIG. 19. FIG. 25 is a back isometric view of the right panel of the inserted core of FIG. 11. FIG. 26 is an isometric view of the release button frame for the inserted core of FIGS. 7-10. FIG. 27 is a front view of the release button frame of FIG. 26. FIG. 28 is a cross-sectional view through Section H-H of the release button frame of FIG. 27. FIG. 29 is a back view of the release button frame of FIG. 26. FIG. 30 is a front view of the release button for the inserted core of FIGS. 7-10. FIG. 31 is a side view of the release button of FIG. 30. FIG. 32 is a back view of the release button of FIG. 30. FIG. 33 is an isometric view of the release button of FIG. 30. FIG. 34 is a cross-sectional view through Section I-I of the release button of FIG. 30. FIG. 35 is an isometric view of a secure block for the release button assembly of FIGS. 26 through 34.

A mounting section 100 (assembled in FIG. 4) consists of the main housing 101, a power board 102, and brass caps 103, as shown in FIGS. 1 through 6. A core box 104, which is removable, is detailed as a unit and with individual components in FIGS. 7-35. The core box 104 reversibly inserts into the mounting section 100, as in FIGS. 7 through 13. The core box 104 is removable by pressing a button 106, part of the button assembly 105 of FIGS. 26 through 35. FIGS. 7 to 10 and 13 have an outlet cover 110, which is there for aesthetics and safety. FIGS. 20 through 24 show the left cover 111 of the core 104. FIG. 25 shows the right cover 112 of the core 104.

The core box 104 has pins 121 which, when core box 104 is inserted into the mounting section 100, contact the brass caps 103 and pass power into cord 150 through brass caps 119 of the reel 113, detailed below.

Button assembly 105 consists of a button frame 107 (FIGS. 26 through 29), a button 106 (FIGS. 30 to 34), a set of springs 108, and a secure block 109 (FIG. 35). The button 106 is pressed by the user, depressing springs 108, and pressing the secure block 109 deeper into the core box 104, engaging the reel 113 and releasing the teeth 114 so it retracts the cord 150 onto the reel 113.

The reel 113 is internal to the core box 104 and is detailed in FIGS. 14 through 18. The reel outer shell 114 contains the remaining parts. A reel inner shell 116 and bearing mount right 115 together house a reel spring 117 that is tightened by pulling the cord 150 out of the core box 104 and released as the cord 150 is retracted into the core box 104 and onto the reel 113. A sprocket 122 inside the core box 104 engages the teeth 114 until the button 106 is pressed and the sprocket 122 is pushed to disengage the teeth 114. Pogo pins 118 mount to either side of the bearing mount left 120 and the bearing mount right 115. The pogo pins 118 attach internally to the cord 150, acting as the pass through for electricity to pass into the cord 150. Brass caps 119 attach to the pogo pins and make connection to conductors on the interior of the core box 104, which connect to the brass caps 103 of the mounting section 100 via pins 121.

With the parts detailed above, the system is detailed here. The mounting section 100 is configured to connect to external electrical power via a power board 102 which provides electrical power via brass caps 103, which mount on the power board 102. The removable core 104 is inserted into the mounting section 100 and pins 121 are configured to make contact with the brass caps 103 and convey power via reel 113 through the cord 150. The reel 113 is configured to allow a user to unspool the cord 150 out of the removable core 104 and extend it to provide electrical power. In this case, cord 150 is an iPhone charger configured to provide electrical power to an appropriate electronic device. When the user is done, the button assembly 105 is configured to have the user press the button 106, and the sprocket 122 disengages from the teeth 114 of the reel 113 and allow the cord 150 to retract and spool around the reel 113.

In this and other embodiments, the reel 113 is configured to lock the retractable cord 150 at a plurality of lengths as the user extends the retractable cord 150.

In other embodiments, the iPhone charger is replaced with a USB-A, USB-B, USB-C, 110 V AC, 220 V AC, or other international AC outlets, both past and present. In the future, as new USB or other standard power carriers are created, this device is designed to incorporate any of them.

In some embodiments, the retractable cord is configured to provide power to a consumer electronic device.

In some embodiments, the mounting section is configured to mount on a standard electrical outlet. In some embodiments, the mounting section is configured to mount into a standard electrical gang box. In some embodiments, the mounting section further comprises an electrical gang box.

In some embodiments, a locking mechanism is configured to hold the removable core in place. In other embodiments, the removable core is removable without unlocking.

In some embodiments, the removable core is configured to be replaced by a user.

In some embodiments, the reel comprises teeth configured to engage the reel and prevent the reel from retracting the retractable cord. In some embodiments, the removable core further comprises a retractor configured to disengage the teeth from the reel and cause the reel to retract the retractable cord. In some embodiments, the retractor is a button pressed by a user.

In some embodiments, the removable core further comprises an outlet configured to provide independent electrical power. In some embodiments, the mounting section further comprises an outlet configured to provide independent electrical power.

The invention of claim 1, wherein the retractable cord comprises an end chosen from the group consisting of USB-A, USB-B, USB-C, 110V AC outlet, 220V AC outlet, and other international AC outlets.

In some embodiments, the retractable cord provides power to a consumer electronic device.

In some embodiments, the retractable cord extends by a user pulling on the retractable cord, thereby unspooling the retractable cord from the reel, and the reel comprises a spring that retracts when the retractable cord when the user engages the spring.

In some embodiments, the reel comprises teeth that lock the retractable cord at a plurality of lengths as the user extends the retractable cord. In some embodiments, the removable core further comprises a retractor that interacts with the teeth to disengage them from the reel and cause the reel to retract the retractable cord.

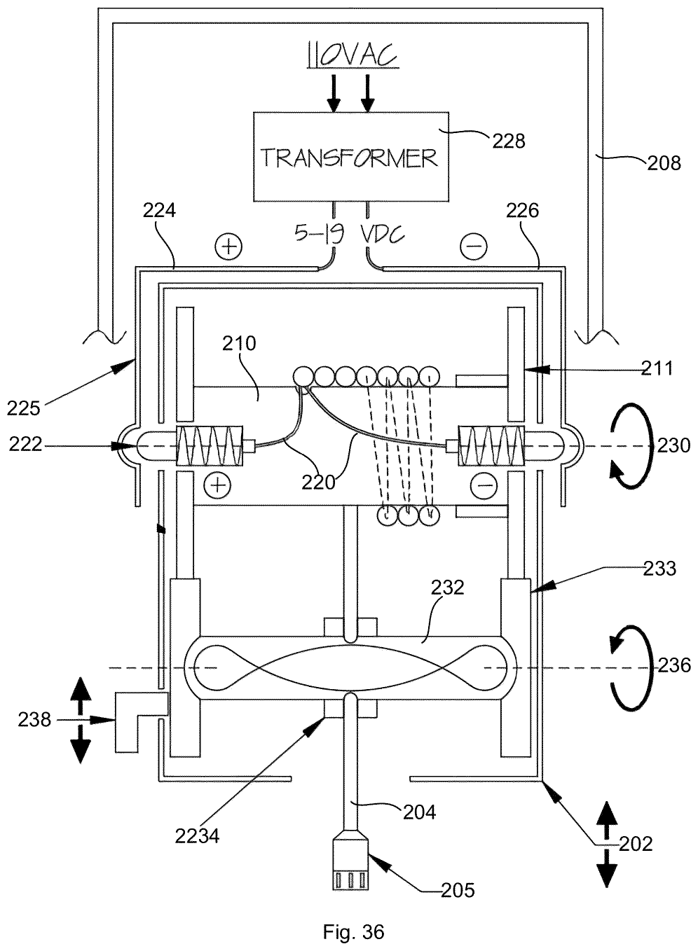

FIG. 36 is a cross-sectional cutaway view of a mounted cord dispenser that may be used in one embodiment of the present invention. An electrical gang box 208 is used to mount a removable core 202. In other embodiments, an existing electrical gang box is used and 208 is a mounting section, as in FIG. 1. Electrical connections of 110 VAC are made by a qualified person to the electrical gang box 208, which contains a transformer 228 that transforms the 110 VAC to 5-19 VDC, conveyed along wires 224 and 226 to brass plates 225 on either side of the core 202. A USB cable 204 is spooled on a reel 210 and has an end 205. The reel 210 is configured to allow a user to draw the head 205 out, unspooling the cord 204 and then charging an electronic device. The reel 210 is configured to lock in place once the cord 104 is unspooled and then to respool when the user tugs on the cord 204. The reel 210 is carried on reel gear 211 and rotates 230 around the reel gear 211. Inside the reel 210 are pogo pins 222 which make contact with wires 224 and 226 and connect to cord 204 via internal wires 220. The cable 204 is directed onto the reel 210 by a cam follower 234 which follows a cam 232 and rotates 236 around a cam gear 233. The core 202 is removable and is locked in place with a locking spring 238. While current standards for charging portable electronic devices call for a USB-C, history shows that this standard may change in the future. Or the user may damage the cord 204. As such, the removable core 202 can be withdrawn and a replacement core can be inserted with a new cord and even a new head. In summary, the power is transmitted from the building's 110 VAC power system, through a transformer, into the pogo pins and through the center of the reel into the cord.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

1. A system for providing electrical power, comprising:
a mounting section configured to connect to external electrical power and convey electrical power to a removable core;
the removable core configured to be inserted into and removed from the mounting section;
the removable core comprising a power connection configured to receive the electrical power from the mounting section and convey the electrical power through a retractable cord; and
the removable core further comprising a reel configured to dispense and retract the retractable cord.

2. The invention of claim 1, wherein the retractable cord is configured to provide power to a consumer electronic device.

3. The invention of claim 1, wherein the retractable cord is configured to extend by a user pulling the retractable cord, thereby unspooling the retractable cord from the reel, and the reel comprises a spring configured to retract the retractable cord when the user engages the spring.

4. The invention of claim 3, wherein the reel is configured to lock the retractable cord at a plurality of lengths as the user extends the retractable cord.

5. The invention of claim 1, wherein the mounting section is configured to mount on a standard electrical outlet.

6. The invention of claim 1, wherein the mounting section is configured to mount into a standard electrical gang box.

7. The invention of claim 1, wherein the mounting section further comprises an electrical gang box.

8. The invention of claim 1, wherein a locking mechanism is configured to hold the removable core in place.

9. The invention of claim 1, wherein the removable core is configured to be replaced by a user.

10. The invention of claim 1, wherein the reel comprises teeth configured to engage the reel and prevent the reel from retracting the retractable cord.

11. The invention of claim 10, wherein the removable core further comprises a retractor configured to disengage the teeth from the reel and cause the reel to retract the retractable cord.

12. The invention of claim 11, wherein the retractor is a button pressed by a user.

13. The invention of claim 1, wherein the removable core further comprises an outlet configured to provide independent electrical power.

14. The invention of claim 1, wherein the mounting section further comprises an outlet configured to provide independent electrical power.

15. The invention of claim 1, wherein the retractable cord comprises an end chosen from the group consisting of USB-A, USB-B, USB-C, 110V AC outlet, 220V AC outlet, and other international AC outlets.

16. A device for providing electrical power, comprising:
a mounting section with first electrical connections to external electrical power and second electrical connections to a removable core;
the removable core shaped to be inserted into and removed from the mounting section;
the removable core comprising a third electrical connection shaped to connect to the second electrical connections and connected to a retractable cord; and
the removable core further comprising a reel whereon the retractable cord mounts, the reel dispensing and retracting the retractable cord.

17. The invention of claim 16, wherein the retractable cord provides power to a consumer electronic device.

18. The invention of claim 16, wherein the retractable cord extends by a user pulling on the retractable cord, thereby unspooling the retractable cord from the reel, and the reel comprises a spring that retracts when the retractable cord when the user engages the spring.

19. The invention of claim 18, wherein the reel comprises teeth that lock the retractable cord at a plurality of lengths as the user extends the retractable cord.

20. The invention of claim 19, wherein the removable core further comprises a retractor that interacts with the teeth to disengage them from the reel and cause the reel to retract the retractable cord.
